(19) United States
(12) Patent Application Publication
(10) Pub. No.: US 2014/0261367 A1
(43) Pub. Date: Sep. 18, 2014

(54) PORTABLE TILE SAW

(71) Applicant: TECHTRONIC POWER TOOLS TECHNOLOGY LIMITED, Tortola (VG)

(72) Inventors: Alek Ipatenco, Belton, SC (US); Michael Hart, Anderson, SC (US); C. Scott Tennant, Clemson, SC (US); Kenneth Brazell, Piedmont, SC (US); Jesse J. Jerabek, Anderson, SC (US); Taku Ohi, Greer, SC (US)

(73) Assignee: TECHTRONIC POWER TOOLS TECHNOLOGY LIMITED, Tortola (VG)

(21) Appl. No.: 13/832,287

(22) Filed: Mar. 15, 2013

(51) Int. Cl. B28D 1/04

(52) U.S. Cl. CPC B28D 1/04
USPC 125/13.01

(57) ABSTRACT

A tile saw for cutting a workpiece includes a frame having a guide that extends from a first end to a second end. A first engagement member and second engagement member are coupled to the frame and disposed adjacent the first end, and a third engagement member is disposed adjacent the third end. A saw is coupled to the frame and is operable to rotate a cutting blade about an axis and a table is operable to support the workpiece. A pan is positioned to support the frame and contain a quantity of coolant. A fourth engagement member is coupled to the third engagement member and a first latch is selectively coupled to the first engagement member. A second latch is selectively coupled to the second engagement member. The first and second latch and the fourth engagement member cooperate to restrict movement of the frame with respect to the pan.

### BACKGROUND

The present invention relates to a portable tile saw. More specifically, the present invention relates to a portable wet tile saw including a pan having integrated wheels, an integrated handle, and an integrated latching mechanism that allows for easy attachment to the saw.

### SUMMARY

In one construction, the invention provides a tile saw for cutting a workpiece. The tile saw includes a frame having a guide that extends from a first end to a second end. A first engagement member and a second engagement member are coupled to the frame and disposed adjacent the first end, and a third engagement member is disposed adjacent the third end. A saw is coupled to the frame and is operable to rotate a cutting blade about an axis and a table is operable to support the workpiece. The table is coupled to the guide and is operable to move the workpiece into cutting engagement with the cutting blade. A pan is positioned to support the frame and to contain a quantity of coolant. A fourth engagement member is coupled to the third engagement member, a first latch is selectively coupled to the first engagement member, and a second latch is selectively coupled to the second engagement member. The first latch, the second latch, and the fourth engagement member cooperate to restrict movement of the frame with respect to the pan.

In another construction, the invention provides a tile saw for cutting a workpiece. The tile saw includes a frame having a first guide rail, a second guide rail, an engagement portion and a saw coupled to the frame and operable to rotate a cutting blade about an axis that is substantially normal to the first guide rail and the second guide rail. A table is operable to support the workpiece. The table is coupled to the first guide rail and the second guide rail and is operable to move the workpiece into cutting engagement with the cutting blade. A pan is positioned to support the frame and to contain a quantity of coolant. The pan includes a first end adjacent a first end of the first guide rail and a second end adjacent a second end of the guide rail. A latch is coupled to the first end of the pan and selectively engageable with the engagement portion of the frame to selectively attach the pan to the frame. A pair of wheels is coupled to the pan adjacent the second end of the pan and a handle is coupled to the first end of the pan.

In yet another construction, the invention provides a tile saw including a frame, a saw coupled to the frame, and a table movable with respect to the saw to move a workpiece into engagement with a cutting blade. The tile saw includes a pan selectively coupled to the frame and operable to contain a liquid coolant. The pan includes a first end and a second end. A slot is formed at a first end of the pan and is operable to receive a portion of the frame. A first latch is attached to the pan and is selectively coupled to the frame, and a second latch is attached to the pan and selectively coupled to the frame. The first latch, the second latch, and the slot cooperate to fixedly attach the frame to the pan. A pair of wheels is coupled to the pan adjacent the first end of the pan and a handle is coupled to the second end of the pan.

Other aspects of the invention will become apparent by consideration of the detailed description and accompanying drawings.

### BRIEF DESCRIPTION OF THE DRAWINGS

FIG. 1 is a perspective view of a wet tile saw supported on a stand;

FIG. 2 is a perspective view of a pan for a wet tile saw supported on the stand;

FIG. 3 is an enlarged perspective view of a latch;

FIG. 4 is an enlarged perspective view of one end of the pan and frame in an assembled condition;

FIG. 5 is an enlarged perspective view of the end of the pan of FIG. 4 with the frame removed;

FIG. 6 is a perspective view of a bottom of one end of the pan illustrating a pair of wheels; and

FIG. 7 is a perspective view of a handle of the pan.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

The present invention provides a wet tile saw 10 that can be used to accurately and quickly cut construction materials such as ceramic, marble, or granite tiles and the like. The tile saw 10 employs a lubricant such as water to cool a cutting blade 15 and to carry away debris removed during the cutting process. As illustrated in FIG. 1, the wet tile saw 10 includes a saw 20, a table 25, a frame 30, a pan 35, an extension 40, and a stand 45 that supports the other components at a suitable working height.

The frame 30 is a structural component that includes a pair of rails 50 that extend along a longitudinal axis 55 of the tile saw 10 and cooperate to define a guide. As is best illustrated in FIGS. 3 and 4, the rails 50 are spaced apart from one another such that they are on opposite sides of the frame 30. In the illustrated construction, the rails 50 are substantially cylindrical rods that extend the length of the frame 30 and that are supported by a structural member 60 such as a channel component or an I-beam component. Each rail 50 is supported in a manner that allows for engagement of a bottom portion of the rail 50 as well as a top portion as will be discussed below.

The frame 30 also includes an engagement member in the form of a tab 65 that extends from one end of the frame 30 between the rails 50. As is best illustrated in FIG. 4, the tab 65 is a trapezoidal member that includes a narrow portion spaced away from the frame 30 and a wider portion at the frame 30. Thus, the tab 65 narrows as it extends away from the frame 30 and defines two tapered surfaces 70. While the illustrated tab 65 is trapezoidal, other shapes or combinations could be employed. For example, a cylindrical or conical tab could be employed. In addition, multiple tabs of different shapes could be employed in place of or in conjunction with the illustrated tab 65.

With reference to FIG. 3, the frame 30 also includes additional engagement members in the form of two hook members 75. FIG. 3 illustrates one of the hook members 75 which is substantially aligned with one of the rails 50. The other hook member 75 is positioned adjacent the same end of the opposite rail 50. Each hook member 75 defines a slot 80 that is preferably cylindrical and that extends in a direction substantially perpendicular to the longitudinal axis 55 of the saw 10. In preferred constructions, the slots 80 of the two hook members 75 are substantially aligned along a common axis. In the construction of FIG. 3, the hook members 75 are formed as part of the frame 30. However, other constructions may include hook members 75 that attach to the frame 30 using a fastener or other attachment means.

With reference to FIG. 1, the saw 10 includes an electrically-powered circular saw 20 (line powered or battery powered) supported by an arm 85 that fixedly attaches to a platform 90 of the frame 30. The arm 85 is shaped to support the saw 20 over the frame 30 in a position where the cutting blade 15 is approximately centered between the rails 50. The saw 20 supports the cutting blade 15 for rotation about an axis that is substantially normal to the axis of the saw 55. In preferred constructions, the circular saw 20 is movable to position the blade 15 at an angle that allows for angled cuts as well as the more common vertical or straight cuts.

With continued reference to FIG. 1, the table 25 includes a substantially planar top surface 95 that is arranged to support a workpiece to be cut. The top surface 95 includes a plurality of grooves or slots 100 arranged to direct the liquid coolant and collected cutting debris off the table and into the pan. In addition, the table includes three slots 105 that extend parallel to the saw axis 55 and that are shaped to receive the cutting blade 15 during a cut. A first of the slots 105a is arranged to receive the blade 15 during a vertical cut and is therefore substantially vertical. A second slot 105b is angled at a first angle (e.g., 45 degrees from vertical) to receive the saw blade 15 during a bevel cut at the first angle. A third slot 105c is angled at a second angle (e.g., 60 degrees from vertical) to receive the saw blade 15 during a bevel cut at the second angle. Additional slots 105 could be provided at different angles if desired.

The table 25 also includes a rear fence 110 that provides support for the workpiece as it is being pushed into the blade 15 during the cutting operation. In the illustrated construction, the fence 110 includes measuring indicia that help the user during the cut setup. In addition, the three slots 105 pass through the fence 110 to provide clearance for the cutting blade 15 during a cutting operation. In some constructions, a second fence is attachable to the table 25 to provide lateral support for the workpiece during a cut. Preferably, the second fence can be angled to support the workpiece in a non-square position to make cuts that are not parallel to the edges of the workpiece.

With continued reference to FIG. 1, the table 25 includes a plurality of roller elements 115 that are arranged to engage the rails 50 and support the table 25 on the rails 50. In the illustrated construction, three roller elements 115 are positioned on each side of the table 25 to engage the rail 50 on that side of the table 25. At least two of the roller elements 115 include a bottom roller that engages the bottom surface of the rail 50. The bottom rollers inhibit unwanted upward movement of the table 25 during a cutting operation. At least two of the roller elements 115 on each side also include a top element that engages the top surface of the rail 50 to support the table 25 for smooth rolling movement along the rails 50. In other constructions, the top and bottom rollers are replaced by linear bearings or other components that engage both sides of the rail 50 and inhibit all movement in directions normal to the rail 50.

The extension 40, best illustrated in FIG. 1 attaches to the pan 35, the frame 30, or the stand 45 and extends beyond the pan 35 behind the saw 20. The extension 40 is angled to catch lubricant that splashes in the rearward direction and direct the lubricant back to the pan 35. In some constructions, one or more side extensions are also employed to perform a similar function along the sides of the pan 35.

The stand 45, illustrated in FIGS. 1 and 2 includes four legs 120 attached to one another in pairs to define two similar side members that move in a manner similar to a scissors. Each leg 120 includes a bottom portion that is adjustable to allow the user to adjust the ultimate height of the saw 10. Lateral members 125 extend between the two side members and connect them to one another. In addition, two rods 130 extend across the upper ends of the legs 120 to interconnect the side members and to provide an attachment point for the pan 35. In the illustrated construction, the rods 130 are cylindrical with other shapes or arrangements being possible.

Turning to FIG. 2, the pan 35 is shown with many of the other components removed. The pan 35 includes an inside bottom surface 135 that is surrounded by an outer wall 140 to define a volume that is capable of containing a liquid, typically water or other lubricants or coolants. In the illustrated construction, the outer wall 140 is substantially rectangular and includes a first end wall 145, a second end wall 150, a first side wall 155, and a second side wall 160. Of course other shaped outer walls 140 having more or fewer sides could be employed if desired.

An inner wall 165 extends between the first end wall 145 and the second end wall 150 in a direction substantially parallel to the first side wall 155. The inner wall 165 divides the volume into a large volume 170 and a small volume 175. A pump 180 is disposed in a corner between the inner wall 165 and the first side wall 155 adjacent the first end wall 145. The inner wall 165 has a height that positions a top surface 185 of the inner wall 165 at a level that is below a top surface 190 of the outer wall 140. In addition, a portion of the inner wall 165 is removed at the end opposite the pump 180 such that the top surface of the wall in this removed area is lower than the top surface 185 of the remainder of the inner wall 165.

The inner wall 165 includes a first vertical slot 195 and the first side wall 155 includes a similar second vertical slot 200, best illustrated in FIG. 5. In the illustrated construction, the first vertical slot 195 and the second vertical slot 200 are axially offset from one another and are sized to receive a filter 205. The offset of the slots 195, 200 results in the filter 205 being supported at an oblique angle with respect to the saw axis 55 as shown in FIG. 2. In other constructions, the slots 195, 200 are not axially offset and the filter 205 is supported in a position that is substantially normal to the axis 55.

Several dams 210 extend across the bottom surface 135 between the second side wall 160 and the inner wall 165 and between the inner wall 165 and the first side wall 155. The dams 20 are formed and positioned to inhibit the passage of cutting debris. In the illustrated construction, three dams 210 are employed between the second side wall 160 and the inner wall 165 and two dams 210 are positioned between the inner wall 165 and the first side wall 155, with more or fewer being possible.

A first platform 215 is formed in the corner between the first end wall 145 and the second side wall 160 and a second platform 220 is formed in the corner between the second side wall 160 and the second end wall 150. The platforms 215, 220 include top surfaces 225 that are set at a height below the top surface 190 of the outer walls 140. The heights of the first platform 215, the second platform 220, and the inner wall 165 are selected to support the frame 30 at a desired height above the bottom surface 135 of the pan 35.

An engagement member in the form of an engagement platform 230, best illustrated in FIG. 5, is formed adjacent the center of the first end wall 145. The engagement platform 230 extends upward from the inside bottom surface 135 to a desired height. A pocket 235 is formed in the engagement platform 230 and is sized and shaped to receive the tab 65 of the frame 30 as illustrated in FIG. 4. In the illustrated construction, the pocket 235 includes side walls 240 that taper inward to receive the trapezoidal tab 65. A cover plate 245 attaches to the top of the engagement platform 230 and covers a portion of the pocket 235 to partially enclose the pocket 235. In other constructions, the cover plate 245 is formed as part of the engagement platform 230.

With reference to FIGS. 2 and 3, the pan 35 includes two latches 250 that are movably attached to the pan 35 to selectively engage and couple the frame 30 to the pan 35. With reference to FIG. 3, the latch 250 is an over-center latch that includes a hook 255 and an actuator 260. The actuator 260 is pivotally attached to the pan 35 and a first end 265 of the hook 255 is pivotally attached to the actuator 260. A second end 270 of the hook 255 selectively engages one of the slots 80 of the adjacent hook member 75. The actuator 260 is movable between a non-engaged position in which the second end 270 of the hook 255 is movable into and out of engagement with the slot 80 and an engaged position in which the second end 270 of the hook 255 is disposed within the slot 80 and the hook 255 is pulled downward to firmly connect the frame 30 and the pan 35.

As illustrated in FIGS. 2 and 6, the pan 35 also includes two wheels 275 supported for rotation adjacent the first end wall 145. Each wheel 275 is supported for rotation on a bracket 280 which is in turn attached to the pan 35. In the illustrated construction, the wheels 275 are disposed closely to the corners of the first end wall 145 and the first side wall 155 and the first end wall 145 and the second side wall 160, with other positions and arrangements being possible.

With reference to FIGS. 2 and 7 a handle 285 is coupled to the pan 35 adjacent the second end wall 150 opposite the wheels 275. The handle 285 is generally U-shaped and is pivotally connected to the second end wall 150 and allows a user to pull the pan 35 while the two wheels 275 engage and roll along the ground.

As illustrated in FIG. 6, the bottom of the pan includes a plurality of slots 290 formed in two groups on opposite sides of the pan 35. In the illustrated construction, three C-shaped slots 290 are clustered on each side and are aligned along a common axis. The C-shaped slots 290 are sized to receive the rods 130 of the stand 45 to securely couple the pan 35 to the stand 45. A similar arrangement of C-shaped slots 290 is formed on the opposite end of the pan 35 to receive the second rod 130 of the stand 45.

With reference to FIGS. 1, 3, and 4, the assembly of the wet tile saw 10 will now be described. The pan 35 is connected to the stand 45 by pushing the pan 35 downward firmly to engage the C-shaped slots 290 with the rods 130. As the rod 130 slides into the slots 290, the C-shape inhibits the unwanted removal and provides a secure coupling. Next, the user places the pump 180 and the frame 30 into the pan 35. The pump 180 is placed in the corner and the power connections and liquid feed lines are positioned as illustrated in FIG. 4. The frame 30 is supported by the inner wall 165, the first platform 215, and the second platform 220 such that the frame platform 90 covers the pump 180. The tab 65 fits within the pocket 235 with the tapered side walls 70, 240 engaging one another to align the frame 30 and restrain unwanted lateral movement. The cover plate 245 is then attached to the engagement platform 230 to inhibit unwanted upward movement of the tap 65 with respect to the pan 35. The latches 25 are then engaged with the frame 30 as illustrated in FIG. 3 to removably couple the frame 30 to the pan 35. The arm 85 supporting the saw 20 is then attached to the frame platform 90 and the table 25 is positioned on the rails 50 of the frame 30 to complete the assembly of the saw 10. Of course, one of ordinary skill in the art will realize that a different assembly process or order could be employed if desired.

In operation, the assembled saw 10 is positioned at the desired height for use. Water or another coolant is placed in the pan 35 until the pan 35 is filled to a desired operating level. Next, the piece to be cut is positioned on the table 25 and the saw blade 15 is positioned as desired. The saw 20 and the pump 180 are then started. The pump's operation could be tied to the saw 20 such that operation of the saw 20 automatically starts operation of the pump 180. Alternatively, the pump 180 and the saw 20 can be started and stopped separately. The pump 180 directs coolant to the desired locations around the workpiece and the cutting blade 15. The table 25 is then moved to engage the workpiece and the cutting blade 15 to make the desired cut. As material is removed, the coolant carries away both heat and cutting debris and drains back into the pan 35. The debris also collects in the pan 35 and settles to the bottom. As the coolant is drawn into the pump 180, the coolant flows past the dams 210 in the large volume 170. The dams 210 inhibit movement of the debris to aid in separating the debris from the coolant. Eventually, the coolant flows around the inner wall 165 and along the small volume 175 toward the pump 180. The arrangement of the inner wall 165 assures a long flow path for the coolant to allow sufficient time for the entrained debris to settle to the bottom. The filter 205 acts as a final filter to assure that debris is not drawn into the pump 180.

If a user wishes to move the saw 10, the pan 35 is removed from the stand 45 and placed on the ground. The user then grabs the handle 285 and picks up the second end of the saw 10. The wheels 275 rotate into contact with the ground, thereby allowing the user to pull the assembly 10 along the ground.

Various features and advantages of the invention are set forth in the following claims.

1. A tile saw for cutting a workpiece, the tile saw comprising:
a frame including a guide that extends from a first end to a second end, a first engagement member and a second engagement member coupled to the frame and disposed adjacent the first end, and a third engagement member disposed adjacent the second end;
a saw coupled to the frame and operable to rotate a cutting blade about an axis;
a table operable to support the workpiece, the table coupled to the guide and operable to move the workpiece into cutting engagement with the cutting blade;
a pan positioned to support the frame and to contain a quantity of coolant;
a fourth engagement member coupled to the third engagement member;
a first latch selectively coupled to the first engagement member;
a second latch selectively coupled to the second engagement member, the first latch, the second latch and the fourth engagement member cooperating to restrict movement of the frame with respect to the pan.

2. The tile saw of claim 1, further comprising a pump coupled to the pan and operable to pump coolant from the pan to the cutting blade.

3. The tile saw of claim 1, wherein one of the third engagement member and the fourth engagement member is a tab and the other of the third engagement member and the fourth engagement member is a slot sized to receive the tab.

4. The tile saw of claim 1, wherein the first engagement member includes a first slot sized to receive the first latch.

5. The tile saw of claim 4, wherein the second engagement member includes a second slot sized to receive the second latch, the first slot and the second slot being parallel to one another

6. The tile saw of claim 1, wherein the guide includes a first guide rail and a second guide rail parallel to the first guide rail.

7. The tile saw of claim 6, wherein the first latch is disposed adjacent the first guide rail, the second latch is disposed adjacent the second guide rail, and the third engagement member is disposed between the first guide rail and the second guide rail.

8. The tile saw of claim 1, further comprising a pair of wheels coupled to the pan adjacent a first end of the pan and a handle pivotally coupled to a second end of the pan opposite the first end.

9. The tile saw of claim 1, wherein the first latch is an over-center latch.

10. The tile saw of claim 1, further comprising a plurality of recesses formed as part of the pan and adapted to receive a support stand to allow the support stand to support the pan, the frame, the saw, and the table for operation.

11. A tile saw for cutting a workpiece, the tile saw comprising:
a frame including a first guide rail, a second guide rail, and an engagement portion;
a saw coupled to the frame and operable to rotate a cutting blade about an axis that is substantially normal to the first guide rail and the second guide rail;
a table operable to support the workpiece, the table coupled to the first guide rail and the second guide rail and operable to move the workpiece into cutting engagement with the cutting blade;
a pan positioned to support the frame and to contain a quantity of coolant, the pan including a first end adjacent a first end of the first guide rail and a second end adjacent a second end of the first guide rail;
a latch coupled to the first end of the pan and selectively engageable with the engagement portion of the frame to selectively attach the pan to the frame;
a pair of wheels coupled to the pan adjacent the second end of the pan; and
a handle coupled to the first end of the pan.

12. The tile saw of claim 11, further comprising a pump coupled to the pan and operable to pump coolant from the pan to the cutting blade.

13. The tile saw of claim 12, wherein the engagement portion includes a first slot adjacent the first guide rail and a second slot parallel to the first slot and adjacent the second guide rail.

14. The tile saw of claim 13, wherein the latch is a first latch that is selectively engageable with the first slot, and wherein a second latch is selectively engageable with the second slot.

15. The tile saw of claim 12, wherein the engagement portion further comprises one of a tab and a groove, and wherein the pan includes the other of the tab and the groove, the tab engageable with the groove to inhibit movement of the frame with respect to the pan.

16. The tile saw of claim 11, wherein the latch is an over-center latch.

17. The tile saw of claim 11, further comprising a plurality of recesses formed as part of the pan and adapted to receive a support stand to allow the support stand to support the pan, the frame, the saw, and the table for operation.

18. A tile saw including a frame, a saw coupled to the frame, and a table movable with respect to the saw to move a workpiece into engagement with a cutting blade, the tile saw comprising:
a pan selectively coupled to the frame and operable to contain a liquid coolant, the pan including a first end and a second end;
a slot formed at a first end of the pan and operable to receive a portion of the frame;
a first latch attached to the pan and selectively coupled to the frame;
a second latch attached to the pan and selectively coupled to the frame, the first latch, the second latch and the slot cooperating to fixedly attach the frame to the pan;
a pair of wheels coupled to the pan adjacent the first end of the pan; and
a handle coupled to the first end of the pan.

19. The tile saw of claim 18, wherein the first latch includes an over center latch and the second latch includes an over center latch.

20. The tile saw of claim 18, further comprising a plurality of recesses formed as part of the pan and adapted to receive a support stand to allow the support stand to support the pan, the frame, the saw, and the table for operation.
